(19) United States
(12) Patent Application Publication
(10) Pub. No.: US 2021/0290463 A1
(43) Pub. Date: Sep. 23, 2021

(54) MOBILE LIFT APPARATUS FOR FACILITATING CARDIOVASCULAR REHABILITATION AND TRAINING OF ELDERLY, OBESE AND INJURED PERSONS

(71) Applicant: Dennis Dubois, Valley Springs, CA (US)

(72) Inventor: Dennis Dubois, Valley Springs, CA (US)

(21) Appl. No.: 17/210,360

(22) Filed: Mar. 23, 2021

Related U.S. Application Data
(60) Provisional application No. 62/993,093, filed on Mar. 23, 2020.

(51) Int. Cl. A61G 7/10

(52) U.S. Cl. CPC A61G 7/1019; A61G 7/1015; A61G 2200/10; A61G 7/1042; A61G 7/1051

(57) ABSTRACT

An apparatus for facilitating cardiovascular rehabilitation and training has an overhead rigging attachable to a harness worn by a user, wherein the overhead rigging is in communication with an upper translatable member slidably joined atop a lower translatable member slidably joined to an upper support of a frame assembly. Columns of the frame assembly retain a plurality of spaced weights to which said overhead rigging is attached via cables. In this arrangement, a user may wear the harness and, via the overhead rigging and weights, have his or her weight against the ground dramatically reduced while being permitted to move about an area substantially defined by the frame assembly. As configured, the upper and lower translatable members move orthogonally to one another providing a tremendous range of motion to the user within the area substantially defined by the frame assembly.

### CROSS-REFERENCE

This application claims priority to U.S. Patent Application No. 62/993,093 filed Mar. 23, 2020 which is incorporated herein by reference for all purposes.

### FIELD OF THE INVENTION

The embodiments of the present invention relate to a lift system for reducing the effective weight of a person during exercise.

### BACKGROUND

Cardiovascular exercises, like running on a treadmill, ground exercises, squats, lunges, etc., can be problematic for the elderly, obese and injured persons because of the high stresses placed on the hips, knees and ankles, and associated ligaments and tendons, of the person. This is especially true for the obese where the extra weight causes large downward forces on the lower extremities. Moreover, the extra weight carried by obese persons causes quick fatigue limiting the length and effectiveness of the workout.

Thus, there is a need for a lift system that reduces the effective weight of the person during exercise. Advantageously, the lift system may utilize a suit that accommodates individuals of different weights and sizes and does so in a comfortable manner. Moreover, the lift system should provide a range of motion (i.e., cardiovascular feature) to the user.

### SUMMARY

Accordingly, the embodiments of the present invention utilize a suit or harness for a user to wear having an overhead rigging attachable to a harness worn by a user, wherein the overhead rigging is in communication with an upper translatable member slidably joined atop a lower translatable member slidably joined to an upper support of a frame assembly. Columns of the frame assembly retain a plurality of spaced weights to which said overhead rigging is attached via cables. In this arrangement, a user may wear the harness and, via the overhead rigging and weights, have his or her weight against the ground dramatically reduced while being permitted to move about an area substantially defined by the frame assembly. As configured, the upper and lower translatable members move orthogonally to one another providing a tremendous range of motion to the user within the area substantially defined by the frame assembly.

Movement within the area substantially defined by the frame assembly is afforded by the upper and lower translatable members. As configured in one embodiment, the upper and lower translatable members move orthogonally to one another providing a tremendous range of motion to the user within the area substantially defined by the frame assembly.

Other variations, embodiments and features of the present invention will become evident from the following detailed description, drawings and claims.

### BRIEF DESCRIPTION OF THE DRAWINGS

FIGS. 1-3 illustrate various views of a frame assembly according to the embodiments of the present invention;

FIG. 4 illustrates a front view of the lift system being used by a person according to the embodiments of the present invention;

FIG. 5 illustrates a view of an overhead rigging according to the embodiments of the present invention;

FIG. 6 illustrates a view of upper and lower translatable members according to the embodiments of the present invention;

FIG. 7 illustrates a view of a corner post of the frame assembly according to the embodiments of the present invention;

FIG. 10 illustrates a rear arm mounting plate according to the embodiments of the present invention;

FIGS. 8A-8C illustrate a range of motion afforded by the apparatus according to the embodiments of the present invention;

FIG. 9 illustrates an exemplary swing swivel of the type utilized by the embodiments of the present invention;

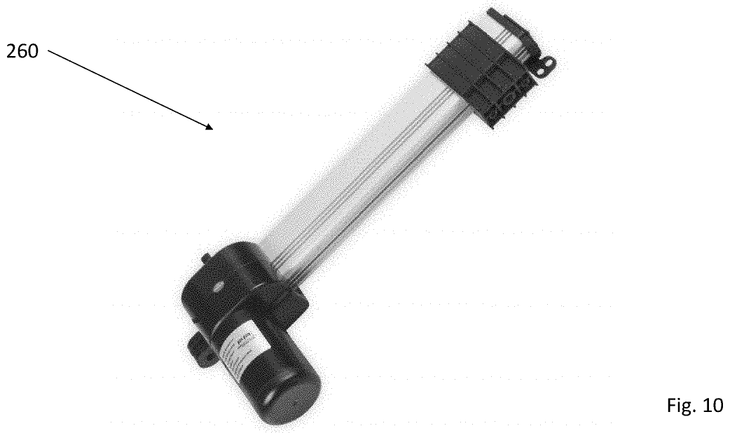

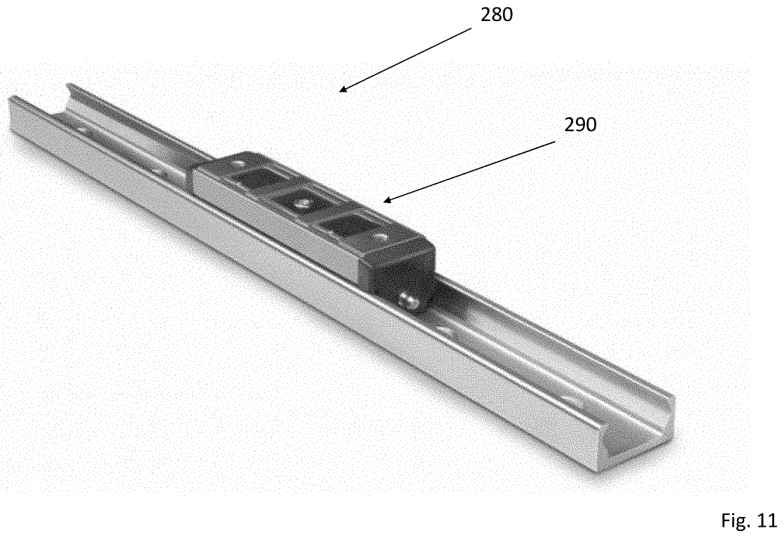

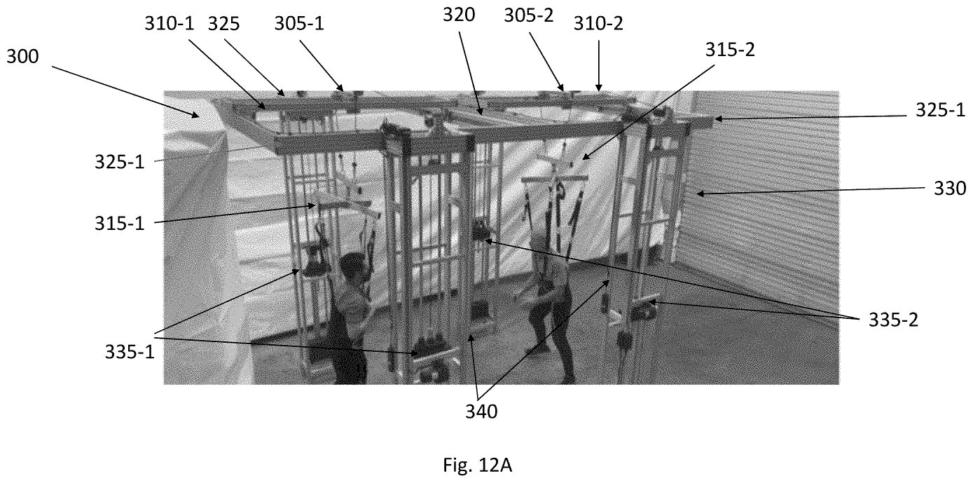

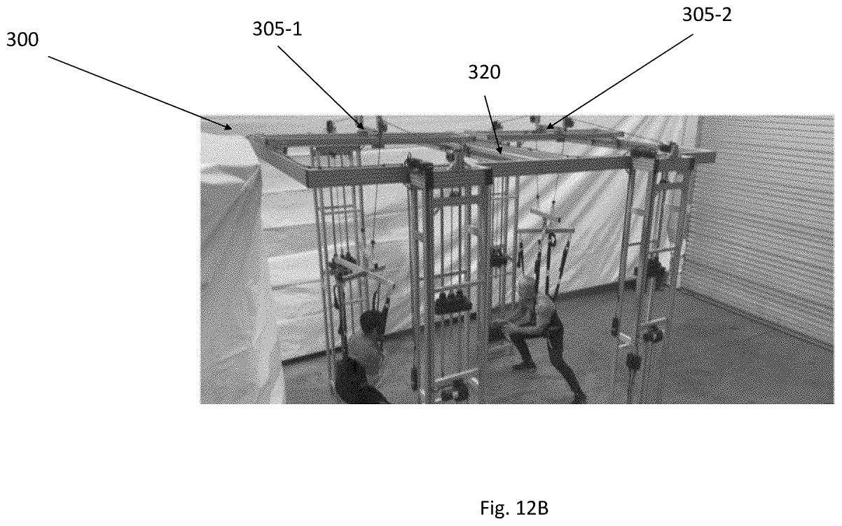

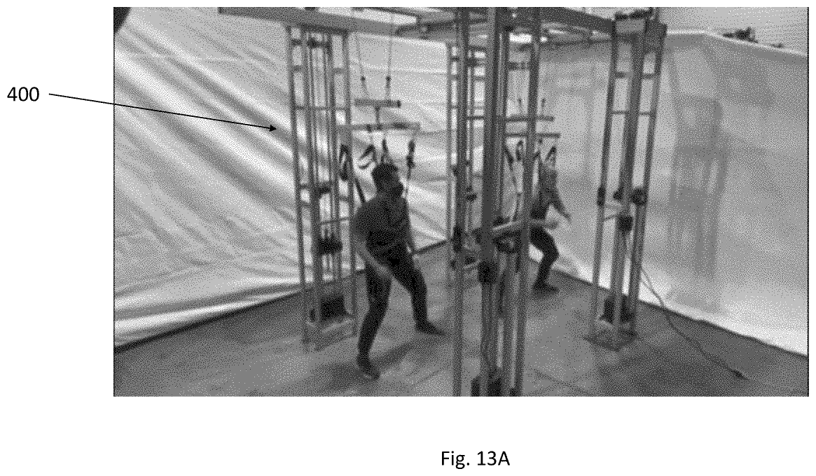

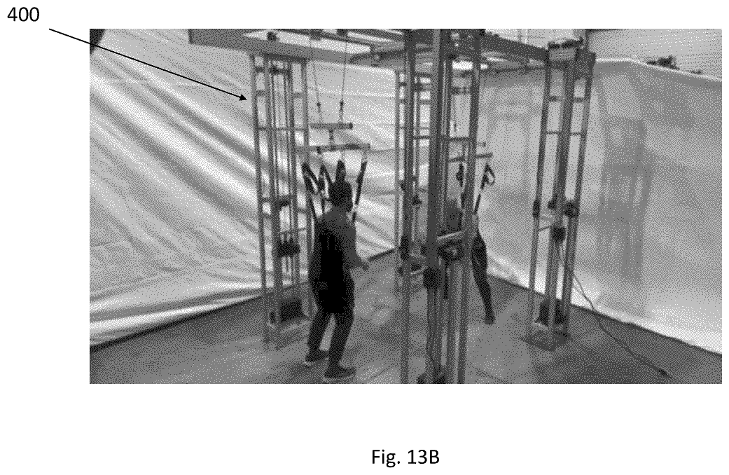

FIG. 10 illustrates an exemplary actuator of the type utilized by the embodiments of the present invention;

FIG. 11 illustrates an exemplary ball bearing roller slider of the type utilized by the embodiments of the present invention;

FIGS. 12A and 12B illustrate a first double lift system according to the embodiments of the present invention; and

FIGS. 13A and 13B illustrate a second double lift system according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

The embodiments of the present invention include a suit and lift system configured to decrease the effective weight of a person during a cardiovascular workout. The decreased weight allows the person to reduce stress on the lower extremities, including joints, ligaments and related internal connective tissues, and extend the duration and effectiveness of the workout. While the suit and lift system are ideal for elderly, obese and injured persons, those skilled in the art will recognize that any class of people may use the suit and lift system described herein.

In one embodiment, a majority of the apparatus 100, including a frame assembly and various other components, is fabricated of aluminum. Of course, those skilled in the art will recognize that other materials including, but not limited to, metals, alloys, composites, woods, plastics and combinations thereof, may be used to fabricate the apparatus 100. The apparatus 100 may also be fabricated using any number of techniques including molding, extruding, machining, additive printing and the like.

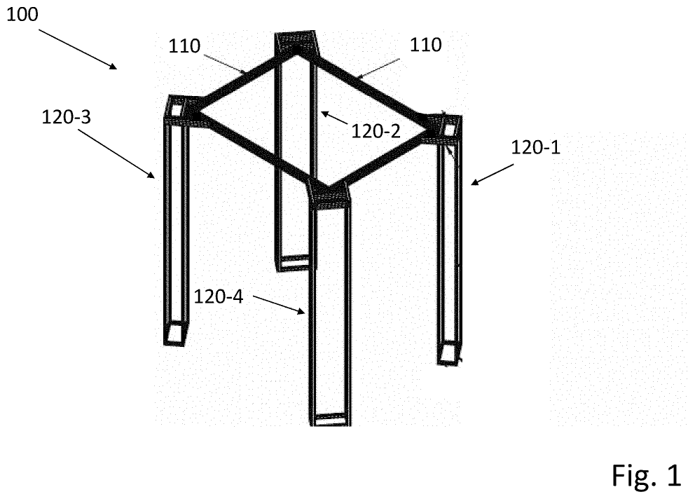

FIGS. 1-3 shows a frame assembly 100 comprising broadly an upper support 110 and four posts or columns 120-1 to 120-4 holding the upper support 110 in position. As shown, each of the columns 120-1 to 120-4 defines a generally internal space for accommodating a weight stack 130 comprising individual weight members for purposes detailed below. Alternatively, the weight stacks may be maintained adjacent the columns rather than within said columns. In one embodiment, the frame assembly is approximately 7′×5.5′×9′. As detailed below, other dimensions are possible.

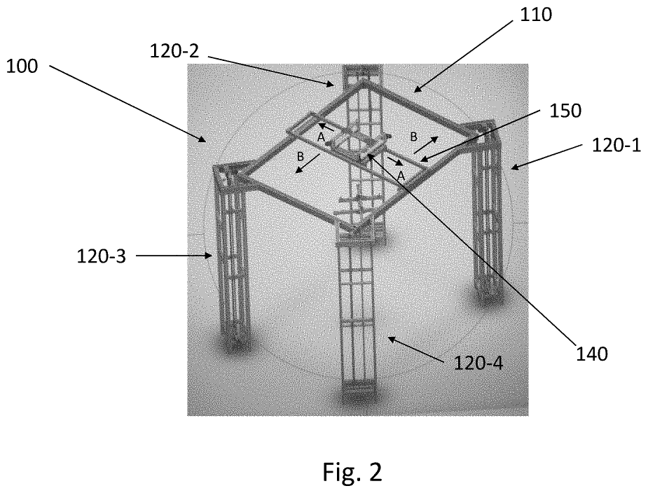

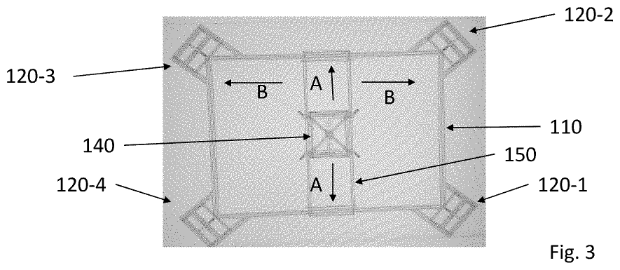

FIGS. 2 and 3 show an upper translatable member 140 and lower translatable member 150. Said lower translatable member 150 is slidably positioned on said upper support 110 and said upper translatable member 140 is slidably positioned on said lower translatable member 150. Arrows A and B show the direction of translation for said upper translatable member 140 and said lower translatable member 150, respectively. Those skilled in the art will recognize that the upper translatable member 150 may be positioned/attached/joined or otherwise in slidable communication with the lower translatable member 140 and lower translatable member 140 may be positioned/attached/joined or otherwise in slidable communication with the upper support 110.

In one embodiment, the upper support 110 and lower translatable member 150 each include rails 280 with ball bearing roller sliders 290 (see, FIG. 11) which allow the upper translatable member 140 and lower translatable member 150 to slide along the lower translatable member 150 and upper support 110, respectively. Other mechanisms may be used as well.

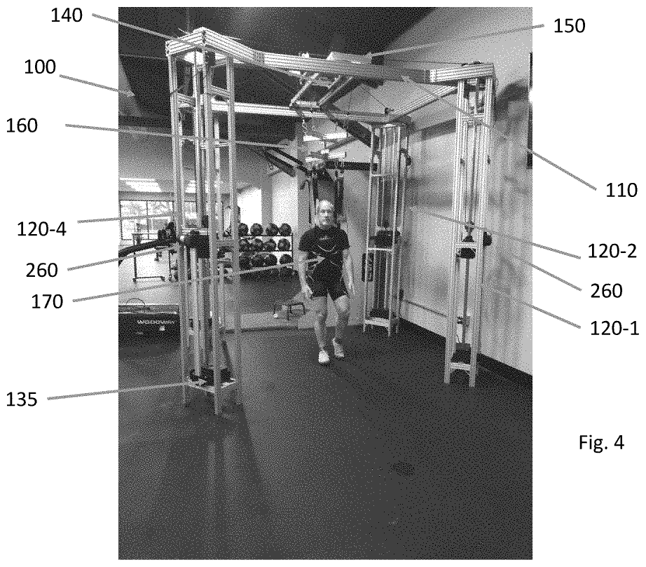

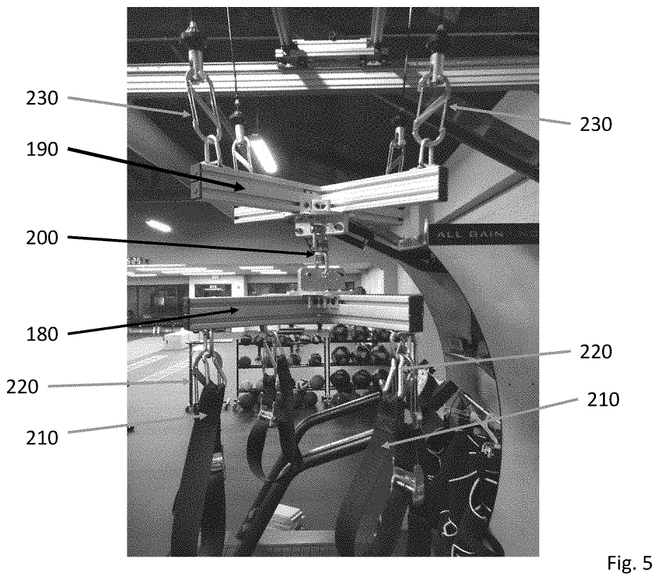

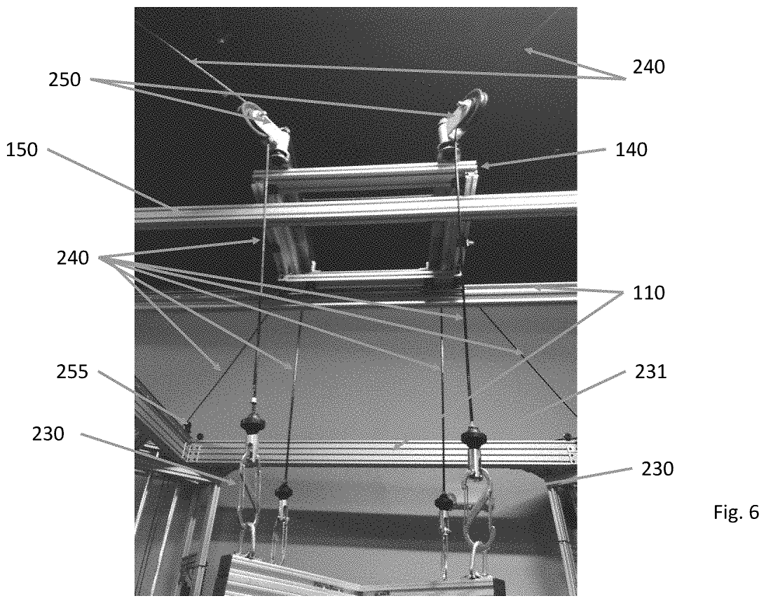

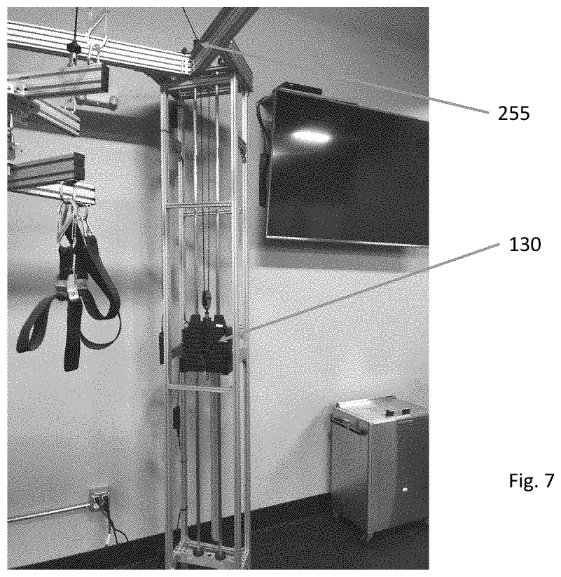

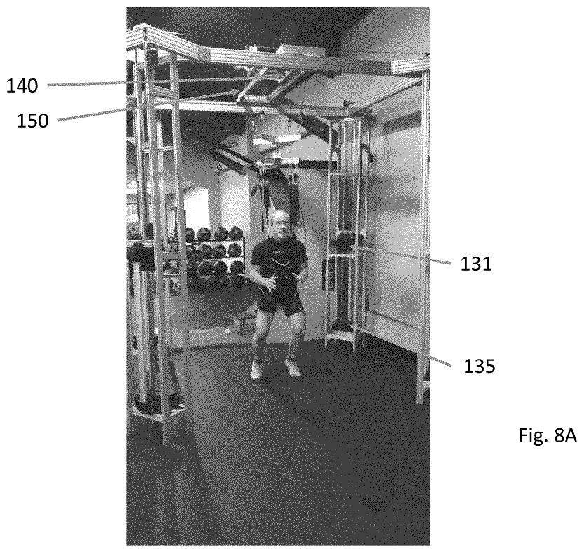

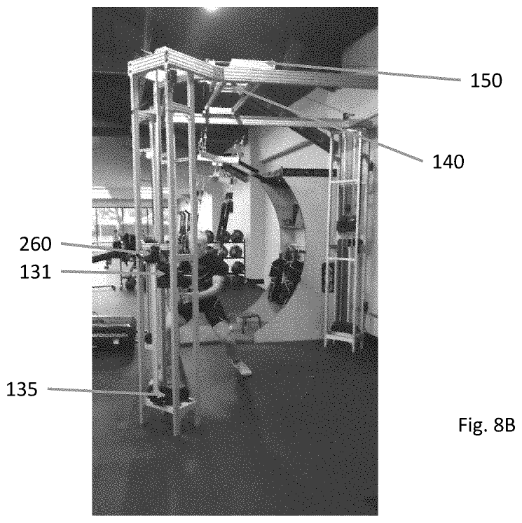

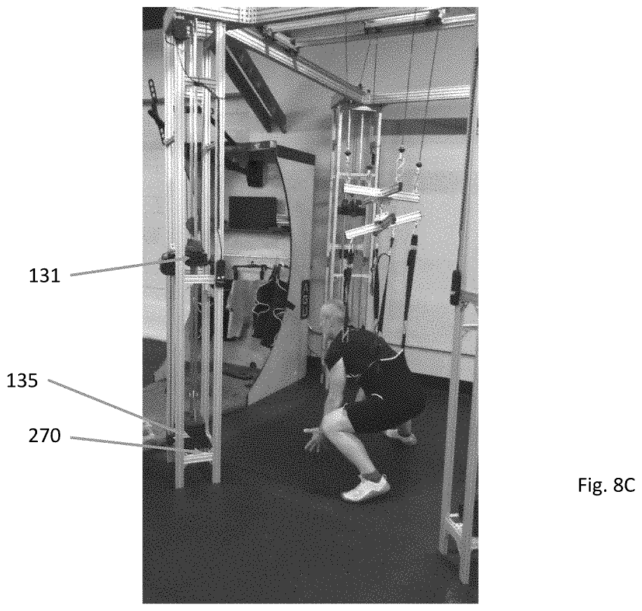

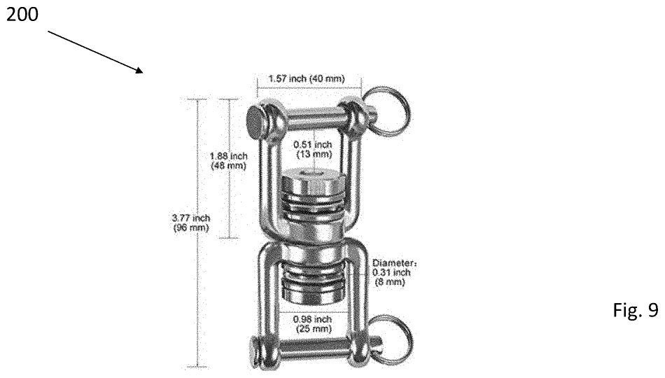

FIG. 4 shows the frame assembly 100 supporting an overhead rigging 160 which is configured to attach to a harness 170 worn by a user. As shown in FIGS. 5 and 6, the overhead rigging 160 comprises a lower section 180 and an upper section 190 connected by a swing swivel 200. As shown, the lower section 180 and an upper section 190 are X-shaped but can take on other shapes and perform the same function. The lower section 180 attaches to a series of straps 210, belts or similar articles which in turn attach to the shoulder area of a harness 170 worn by the user. Carabiners 220 or similar connectors may be used to attach the straps 210 to the lower section 180 and carabiners 230 or similar connectors may be used to attach the upper section 190 to cables 240 leading to weights 250. The four cables 240 each extend from the upper section 190 of the overhead rigging 160 through pulleys 250 integral with said upper translatable member 140 which re-direct the cables to second pulleys 255 incorporated in upper areas of said columns 120-1 to 120-4 to re-direct the four cables 240 to weights 250 positioned within the internal space defines by each column 120-1 to 120-4. In one embodiment, the pulleys 250 are fixed in position on the upper translatable member 140. Alternatively, the pulleys 250 may rotate to accommodate movement of the upper translatable member 140.

In one embodiment, as best seen in FIG. 6, the four cables 240 extend at a slight angle relative to the exact vertical from the upper translatable member 140 to the upper section 190 of the overhead rigging 160. The angle eliminates any unnecessary delay between the user movements and the response of the selected weight stack 130 in each of the columns 120-1 to 120-4. The angle may be maintained by the connector between the cables 240 and the upper section 190 of the overhead rigging 160 or the location of the connection of the cables 240 to the upper section 190 of the overhead rigging 160.

In one embodiment, the overhead rigging comprises the x-shaped lower section 180 and the x-shaped upper section 190 connected by a swing swivel 200. This configuration serves to provide the user with a great deal of freedom when moving about, and since the cables 240 cannot twist, the lower section 180 provides the ability for the user to spin 360° via the swing swivel 200 connecting the lower section 180 and upper section 190. Spinning yokes 231 further assist with preventing any undesired spinning of the cables 240. Alternatively, the overhead rigging may use a different mechanism which allows the cables, via an integral spindle or similar device, to spin. The overhead rigging may be any mechanism that supports the user and permits the user to enjoy a significant degree of freedom.

FIGS. 8A-8C show a user going through various movements within the frame assembly 100. The movement is facilitated by the lower translatable member 150 of the overhead rigging 160 translating along the upper support 110 and the upper translatable member 140 translating orthogonally along the lower translatable member 150. Movement of the upper translatable member 140 is caused by the user moving thereby moving the overhead rigging 160 and cables 240 which run through the pulleys 250, 255. Movement of the lower translatable member 150 is caused by movement of the lower translatable member 140 to which it is slidably connected.

FIGS. 8A-8C show the upper translatable member 140 and lower translatable member 150 moving relative to the upper support 110 and one another as the user moves about conducting cardiovascular activities while in the harness 170 connected to the overhead rigging 160.

When the apparatus is not in use, the weights 250 in each of the columns 120-1 to 120-4 are held in an elevated position by a linear actuator 260 and support plate 270. In one embodiment, the weights 250 are held 42 inches above the ground but those in the art will recognize that the weights may be positioned differently. When a user is ready to use the apparatus 100, a desired weight is selected from each weight stack 130 using a conventional pin arrangement. The weight selected is a function of the weight of the user and his/her physical abilities. That is, the selected weight is more for heavy users and/or those with the ability to move well whereas the selected weight is less for smaller users and/or those with compromised physical abilities.

When the weight is selected by the pin arrangement, the support plate 270 lowers smoothly and gently as controlled by the linear actuator 260. Thus, the excess weight members 135 are lowered out of place allowing the selected weight members 131 to move responsive to the user's motion. In this fashion, the selected weight members 131 function to offset or counterbalance the actual weight of the user so that the physical impact of the activity being performed on the user is lessened while allowing the user to do more without the normal fatigue level. For example, a 200-pound user having had recent knee surgery may perform a series of squats as part of his rehabilitation using the apparatus to lighten the load on the repaired knee while still performing the necessary physical tasks. In another example, the apparatus allows elderly users to perform longer thereby increasing the cardiovascular benefits. Once the user has completed his or her physical tasks, the linear actuator 260 and plate 270 may re-raise the excess weight members 135 back into an elevated position with the selected weight members 131 allowing the user to exit the harness 170 safely.

FIGS. 12A, 12B, 13A and 13B show lift systems 300, 400 configured for multiple persons and designed with a smaller footprint. Allowing multiple persons to train simultaneously is more efficient and allows trainers to create exercises and routines involving interactions between the two persons. Such a dynamic helps patients stay focused and gives them a partner to push them. In one embodiment, lift system 300 is a 5′×7′ lift system while lift system 400 is a 5′×5′ lift system. In either case, the system and manner in which it works is as generally described above relative to the single person model.

Lift system 300 includes a pair of upper translatable members 305-1, 305-2, a pair of lower translatable members 310-1, 310-2 and a pair of overhead riggings 315-1, 315-2. In one embodiment, the lower translatable members 310-1, 310-2 share a common central rail member 320 incorporated into an upper support 325 of the frame assembly 330. Alternatively, each of the lower translatable members 310-1, 310-2 may have its own central rail member. In such an embodiment, each overhead rigging 315-1, 315-2 is attached to two weight sets 335-1, 335-2. In one embodiment, portions of the upper support 325-1 extend beyond the columns 340 allowing the multiple users to increase the space therebetween as needed. Lift system 400 operates the same as lift system 300 albeit with a smaller footprint.

Advantageously, as the user is better able to perform his or her cardiovascular tasks, the weight may be increased to accommodate therefor and vice versa if the user is struggling to perform his or her physical the weight may be decreased to help the user perform the physical tasks.

Although the invention has been described in detail with reference to several embodiments, additional variations and modifications exist within the scope and spirit of the invention as described and defined in the following claims.

I claim:

1. An apparatus comprising:
a frame assembly having an upper support and a plurality of columns, each of said columns supporting the upper support and maintaining the frame assembly in an upright position;
an upper translatable member and a lower translatable member, said lower translatable member slidably joined atop said upper support and said upper translatable member slidably joined atop said lower translatable member; and
an overhead rigging, said overhead rigging attached to said upper translatable member via a series of cables, said series of cables attached at second ends to weights maintained adjacent said plurality of columns.

2. The apparatus of claim 1 wherein said columns each define an internal space in which said weights are maintained.

3. The apparatus of claim 1 further comprising a plurality of pulleys connected to said upper translatable member, said plurality of pulleys configured to receive and re-direct said cables to upper areas of said plurality of columns.

4. The apparatus of claim 1 further comprising a plurality of pulleys connected near an upper area of each of said plurality of columns configured to receive and re-direct said cables to weights maintained within said space defined by each of said plurality of columns.

5. The apparatus of claim 1 wherein the overhead rigging comprising an upper member and lower member attached to one another by a swing swivel whereby said lower member may spin 360°.

6. The apparatus of claim 1 further comprising a linear actuator configured to maintain said weights in an elevated positioned within said spaces defined by each of said plurality of columns.

7. The apparatus of claim 6 wherein said linear actuator is configured to lower any portion of weights from said elevated positioned when not needed.

8. An apparatus comprising:
a frame assembly having an upper support and a plurality of columns spaced from one another to define a patient area, each of said columns further defining an internal space and supporting the upper support;
an upper translatable member and a lower translatable member, said lower translatable member slidably joined atop said upper support and said upper translatable member slidably joined atop said lower translatable member; and
an overhead rigging, said overhead rigging attached to said upper translatable member via a series of cables, said series of cables attached at second ends to weights maintained within said internal spaces defined by each of said plurality of columns.

9. The apparatus of claim 8 further comprising a plurality of pulleys connected to said upper translatable member, said plurality of pulleys configured to receive and re-direct said cables to upper areas of said plurality of columns.

10. The apparatus of claim 8 further comprising a plurality of pulleys connected near an upper area of each of said plurality of columns configured to receive and re-direct said cables to weights maintained within said space defined by each of said plurality of columns.

11. The apparatus of claim 8 wherein the overhead rigging comprising an upper member and lower member attached to one another by a swing swivel whereby said lower member may spin 360°.

12. The apparatus of claim 8 further comprising one or more linear actuators configured to maintain said weights in an elevated positioned within said spaces defined by each of said plurality of columns.

13. The apparatus of claim 12 wherein said one or more linear actuators is configured to lower any portion of weights from said elevated positioned when not needed.

14. An apparatus comprising:
a frame assembly having an upper support and a plurality of columns for maintaining the frame assembly in an upright position;
a pair of upper translatable members and a pair of lower translatable members, each of said lower translatable members slidably joined atop said upper support and each of said upper translatable members slidably joined atop a different one of said lower translatable members; and
a pair of overhead riggings, each of said overhead riggings attached to a different one of said upper translatable members via a series of cables, each of said series of cables attached at second ends to weights maintained adjacent to each of said plurality of columns.

15. The apparatus of claim 14 wherein one end of each of said lower translatable members is slidably joined to common central rail member.

16. The apparatus of claim 14 wherein one end of each of said lower translatable members is slidably joined to separate central rail member.

17. The apparatus of claim 14 wherein said columns each define an internal space in which said weights are maintained.

18. The apparatus of claim 14 further comprising a plurality of pulleys connected to said upper translatable member, said plurality of pulleys configured to receive and re-direct said cables to upper areas of said plurality of columns.

19. The apparatus of claim 14 further comprising a plurality of pulleys connected near an upper area of each of said plurality of columns configured to receive and re-direct said cables to weights maintained within said space defined by each of said plurality of columns.

20. The apparatus of claim 14 further comprising one or more linear actuators configured to manage said weights.
